(19) United States
(12) Patent Application Publication
(10) Pub. No.: US 2005/0201535 A1
(43) Pub. Date: Sep. 15, 2005

(54) Classification of wanted e-mail via web of relationship utilization of Public Key Infrastructure (PKI)

(75) Inventors: Robert Clarence LaLonde, Augusta, GA (US); Stephen Anthony Lee, Callahan, FL (US)

Correspondence Address: ROBERT C. LALONDE, 3118 EXETER ROAD, AUGUSTA, GA, 30909, US

(73) Assignees: Robert Clarance LaLonde, Augusta, GA (US); Stephen Anthony Lee, Callahan, FL (US)

(21) Appl. No.: 10/708,968

(22) Filed: Apr. 4, 2004

Related U.S. Application Data
(63) Continuation of application No. 10/708,514, filed on Mar. 9, 2004.

(51) Int. Cl. H04M 11/00

(52) U.S. Cl. 379/93.24

(57) ABSTRACT

An enhanced email system that will allow for categorization of wanted email based on relationships between senders and receivers. Modified email servers and clients will deliver and/or sort email based on defined relationships between senders and receivers or intermediaries and the receivers preferences. This means email delivery or sorting is based on a web of relationship. Support for encryption to multiple members of a group is supported by a system of dynamic delivery and maintenance of group keys.

### CROSS REFERENCE To RELATED APPLICATIONS

This application depends upon the patent application Ser. No. 10/708,514, filed on 2004-03-09 at 13:59:39 EDT, titled “Reduction in unwanted e-mail (spam) through the use of portable unique utilization of public key infrastructure (PKI)”. Specifically, the “Use of unique keys maintained by third party to end users for classification of email” in 10/708,514 allows for proper identification and use of friends lists. It is assumed that “Specific email server and client plug-ins to be developed to support portability” in 10/708,514 can and most likely will be the same as the those that provide the functionality for this invention.

### SUMMARY OF INVENTION

Assuming that all email users are identified by a unique key, then an email system can take advantage of defined relationships.

An email system can record a list of friends, family and close associates. An incoming email can be forwarded to a specific folder or flagged for attention if it comes from someone in that list. Further it could be possible to delete all email from anyone not in that list.

Electronic mail needs to be able to serve as a human networking tool.

To support this, a user can specify “degrees of separation” for each trusted sender or utilize a general setting. Zero degrees of separation would have the effect of only allowing email from those specifically mentioned. One degree of separation would allow email from friends of friends. Delivery of e-mail is then subject to a web of relationship, just a communication in the real world.

A dynamic system of group keys will support encryption, if desired.

### DETAILED DESCRIPTION

This invention depends on the establishment of identity of all senders and receivers in an e-mail system. This can be accomplished via a unique key for each user.

Users of this system will have the option of maintaining lists of friends, associates, family, etc. These lists will be used to categorize e-mail. The relationship of sender to the receiver of an email can cause the e-mail to be deleted, flagged for importance, ignored, placed in specific folders, or a combination of these options.

Users will have the option of maintaining a global setting for “degrees of separation” and/or maintaining the setting for individuals in the relationship lists.

“Degrees of Separation”, denote the number of relationship links a sender can be separated from the receiver. Zero degrees of separation would have the effect of only allowing email from senders specifically mentioned in a relationship list. One degree of separation would allow email from friends of friends. Delivery of e-mail is then subject to a web of relationship, just as communication in the real world.

An unverified sender can be accepted, if the receivers rules allow it. Since an email that does not contain a unique key, could be forged, there is a risk that the message was unwanted. Further any “Degrees of Separation” greater than 0 would be risking even more unwanted email, if senders are not verified. Without a unique key it may also be difficult to reference the senders list of friends, limiting them zero “Degrees of Separation”.

As in many e-mail clients and spam products, a user can specifically blacklist a sender, to prevent the delivery of email from that sender or to just remove any special treatment based on the web of relationship.

This invention can be seen as an enhancement of “Web of trust” as used by PGP. Please note that PGP may not be PKI algorithm used.

Users may have the need to send encrypted e-mail to multiple members of this web of relationship. To support this, the system will create upon need, a group key that is forwarded to each recipient.

These group keys will be sent utilizing the same method as in the patent application for ‘Reduction in unwanted e-mail (spam) through the use of portable unique utilization of public key infrastructure (PKI)’.

The Group keys can have set validity periods. If a group key has expired, then the next attempt to send an encrypted e-mail will result in a new group key.

Group key validity periods and membership must be stored in e-mail servers.

If the group key itself is stored in servers, then additions to group membership can have the key forwarded to them.

Deletion from group membership, requires a new group key be created, otherwise the old group member could decrypt the message.

This method requires no decryption by any intermediary and prevents the need of encrypting for each recipient.

1. Method for degrees of separation and web of relationship for delivery or categorization of e-mail.

2. Specific email server and client plug-ins to be developed to support degrees of degrees of separation and web of relationship.

3. Methods for delivery and maintenance of group PKI.
